(19) United States
(12) Patent Application Publication
(10) Pub. No.: US 2008/0117514 A1
(43) Pub. Date: May 22, 2008

(54) TWO-LAYER OPTICAL PLATE AND METHOD FOR MAKING THE SAME

(75) Inventors: TUNG-MING HSU, Tu-Cheng (TW); SHAO-HAN CHANG, Tu-Cheng,Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/697,307

(22) Filed: Apr. 6, 2007

(30) Foreign Application Priority Data
Nov. 20, 2006 (CN) 200610201109.7

(51) Int. Cl. G02B 5/02

(52) U.S. Cl. 359/599; 359/831

(57) ABSTRACT

An exemplary optical plate (20) includes a transparent layer (21) and a light diffusion layer (22). The transparent layer includes a light input interface (211), a light output surface (212) opposite to the light input interface, and a plurality of depressions (213) defined at the light output surface. The depressions including at least three sidewalls connecting with each other, wherein a transverse width of each sidewall of each depression progressively increasing along a direction away from the light input interface. The light diffusion layer is integrally formed in immediate contact with the light input interface of the transparent layer. The light diffusion layer includes a transparent matrix resin (221) and a plurality of diffusion particles (222) dispersed into the transparent matrix resins. A method for making an optical plate is also provided.

### CROSS-REFERENCE TO RELATED APPLICATIONS

This application is related to nine copending U.S. patent applications, which are: application Ser. No. 11/655,425, filed on Jan. 19, 2007, and entitled “TWO-LAYERED OPTICAL PLATE AND METHOD FOR MAKING THE SAME”; application Ser. No. 11/655,426, filed on Jan. 19, 2007, and entitled “TWO-LAYERED OPTICAL PLATE AND METHOD FOR MAKING THE SAME”; application Ser. No. 11/655,430, filed on Jan. 19, 2007, and entitled “TWO-LAYERED OPTICAL PLATE AND METHOD FOR MAKING THE SAME”; application Ser. No. 11/655,431, filed on Jan. 19, 2007, and entitled “TWO-LAYERED OPTICAL PLATE AND METHOD FOR MAKING THE SAME”; application Ser. No. 11704562, filed on Feb. 9, 2007, and entitled “TWO-LAYERED OPTICAL PLATE AND METHOD FOR MAKING THE SAME”; application Ser. No. 11/704,564, filed on Feb. 9, 2007, and entitled “TWO-LAYERED OPTICAL PLATE AND METHOD FOR MAKING THE SAME”; application Ser. No. 11/713,524, filed on Mar. 2, 2007, and entitled “TWO-LAYERED OPTICAL PLATE AND METHOD FOR MAKING THE SAME”; application Ser. No. 11/713,121, filed on Mar. 2, 2007, and entitled “TWO-LAYER OPTICAL PLATE AND METHOD FOR MAKING THE SAME”; and application Ser. No. 11/684,469, filed on Mar. 9, 2007, and entitled “TWO-LAYERED OPTICAL PLATE AND METHOD FOR MAKING THE SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention generally relates to optical plates and methods for making the same, and more particularly, to an optical plate for use in, for example, a backlight module of a liquid crystal display (LCD).

2. Discussion of the Related Art

The weight and/or the thinness of LCD panels make them suitable for a wide variety of uses in electronic devices such as personal digital assistants (PDAs), mobile phones, portable personal computers, and other electronic appliances. Liquid crystal is a substance that cannot itself emit light; instead, the liquid crystal relies on light received from a light source in order to display data and images. In the case of a typical LCD panel, a backlight module powered by electricity supplies the needed light.

FIG. 11 is an exploded, side cross-sectional view of a typical backlight module 10 employing a typical optical diffusion plate. The backlight module 10 includes a housing 11, a plurality of lamps 12 disposed above a base of the housing 11, and a light diffusion plate 13 and a prism sheet 14 stacked on top of the housing 11 in that order. The lamps 12 emit light, and inside walls of the housing 11 are configured for reflecting received light towards the light diffusion plate 13. The light diffusion plate 13 includes a plurality of embedded dispersion particles. The dispersion particles are configured for scattering light, thus enhancing the uniformity of light exiting the light diffusion plate 13. The front of the prism sheet 14 includes a plurality of V-shaped structures. The V-shaped structures are configured for collimating received light to a certain extent.

In use, light from the lamps 12 enters the prism sheet 14 after being scattered in the diffusion plate 13. The light is refracted by the V-shaped structures of the prism sheet 14 and is thereby concentrated so as to increase a brightness of light illumination. Finally, the light propagates into an LCD panel (not shown) that is disposed above the prism sheet 14. Although the brightness may be improved by the V-shaped structures of the prism sheet 14, the viewing angle may be narrow.

In addition, even though the brightness may be improved by the V-shaped structures, the viewing angle may be narrowed. Because of the manufacturing methodology, a plurality of air pockets are formed between the light diffusion plate 13 and the prism sheet 14. Thus when the backlight module 10 is in use, light passing through the air pockets undergoes total reflection at the air pockets and as a result the brightness is reduced.

Therefore, a new optical means is desired in order to overcome the above-described shortcomings. A method for making such optical means is also desired.

### SUMMARY

In one aspect, an optical plate includes a transparent layer and a light diffusion layer. The transparent layer includes a light input interface, a light output surface opposite to the light input interface, and a plurality of depressions defined at the light output surface. The depressions including at least three sidewalls connecting each other, wherein a transverse width of each sidewall of each depression progressively increasing along a direction away from the light input interface. The light diffusion layer is integrally formed in immediate contact with the light input interface of the transparent layer. The light diffusion layer includes a transparent matrix resin and a plurality of diffusion particles dispersed into the transparent matrix resins.

In another aspect, a method for making an optical plate includes the following steps: heating a first transparent matrix resin to a melted state; heating a second transparent matrix resin to a melted state; injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of protrusions formed at an inmost end of the at least one molding cavity, each protrusion including at least three sidewalls, a transverse width of each sidewall decreasing along a direction from a base end of the protrusion to an outmost end of the protrusion, a portion of the at least one molding cavity and the at least one male mold cooperatively forming the first molding chamber; moving the at least one male mold a distance away from the inmost end of the at least one molding cavity of the female mold; injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and taking the combined transparent layer and light diffusion layer out of the at least one molding cavity of the female mold.

In still another aspect, another method for making an optical plate includes the following steps: heating a first transparent matrix resin to a melted state; heating a second transparent matrix resin to a melted state; injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber; withdrawing the first male mold from the female mold; injecting the melted second transparent matrix resin into a second molding chamber of the two-shot injection mold to form a transparent layer of the optical plate on the light diffusion layer, the molding cavity of the female mold receiving the second one of the male molds, the second male mold including a plurality of protrusions formed at a molding surface thereof, each protrusion including at least three sidewalls, a transverse width of each sidewall decreasing along a direction from a base end of the protrusion to an outmost end of the protrusion, a portion of the molding cavity, the light diffusion layer, and the second male mold cooperatively forming the second molding chamber; and taking the combined light diffusion layer and transparent layer out of the molding cavity of the female mold.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and method. Moreover, in the drawings, like reference numerals designate corresponding parts throughout various views, and all the views are schematic.

FIG. 1 is an isometric view of an optical plate in accordance with a first embodiment of the present invention.

FIG. 2 is an enlarged view of a circled portion 11 of FIG. 1.

FIG. 3 is a top plan view of the optical plate of FIG. 1.

FIG. 4 is a cross-sectional view taken along line IV-IV of FIG. 3.

FIG. 5 is a top plan view of an optical plate in accordance with a second embodiment of the present invention.

FIG. 6 is a top plan view of an optical plate in accordance with a third embodiment of the present invention.

FIG. 7 is a top plan view of an optical plate in accordance with a fourth embodiment of the present invention.

FIG. 8 is a side cross-sectional view of a two-shot injection mold used in an exemplary method for making the optical plate of FIG. 1, showing formation of a transparent layer of the optical plate.

FIG. 9 is similar to FIG. 8, but showing subsequent formation of a diffusion layer of the optical plate on the transparent layer, and showing simultaneous formation of a transparent layer of a second optical plate.

FIG. 10 is a side, cross-sectional view of another two-shot injection mold used in another exemplary method for making the optical plate of FIG. 1.

FIG. 11 is an exploded, side cross-sectional view of a conventional backlight module.

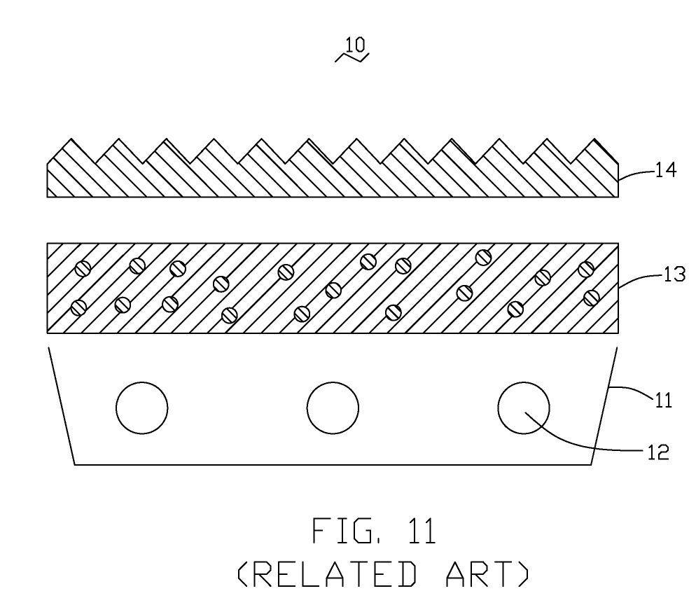

### DETAILED DESCRIPTION OF THE EMBODIMENTS

Reference will now be made to the drawings to describe preferred embodiments of the present optical plate and method for making the optical plate, in detail.

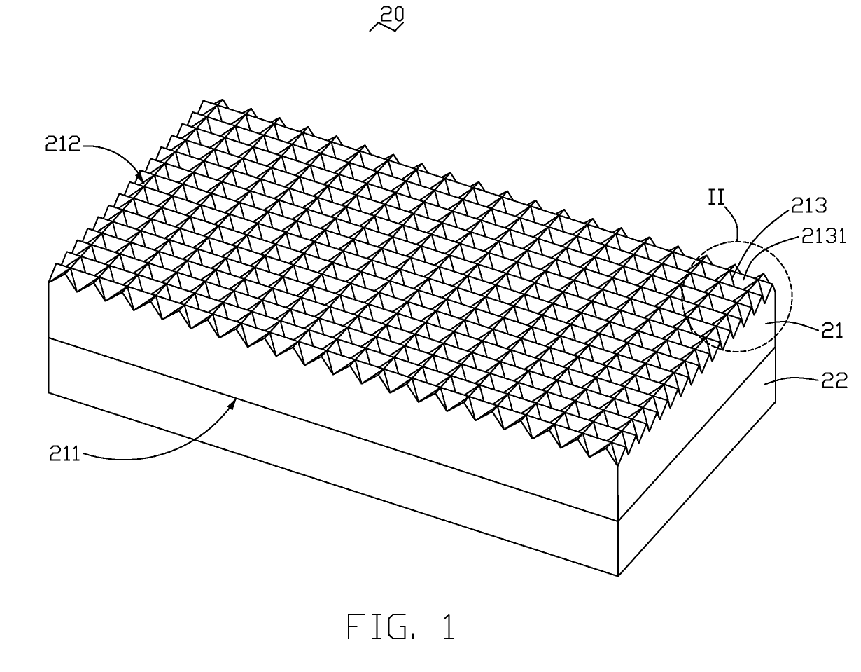

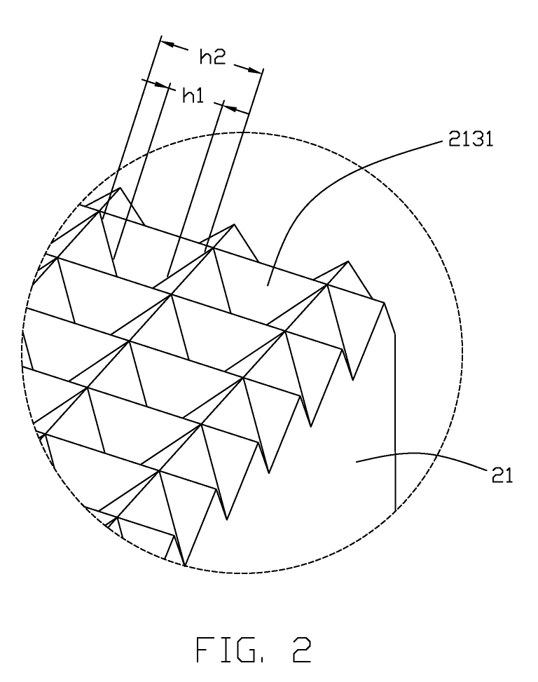

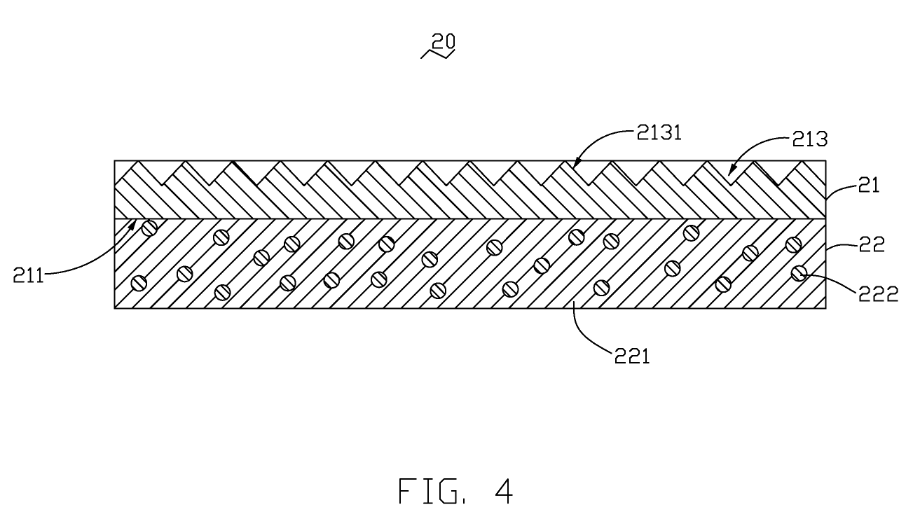

Referring now to FIGS. 1-4, these show an optical plate 20 according to a first embodiment. The optical plate 20 includes a transparent layer 21 and a light diffusion layer 22. The transparent layer 21 and light diffusion layer 22 are integrally formed by two-shot injection molding. That is, the transparent layer 21 and light diffusion layer 22 are in immediate contact with each other at a common interface therebetween. The transparent layer 21 includes a light input interface 211, a light output surface 212 opposite to the light input interface 211, and a plurality of depressions 213 defined at the light output surface 212. The depressions 213 are arranged regularly in a matrix, and are connected with one another. Each of the depressions 213 is defined by at least three sidewalls connected with each other. In the illustrated embodiment, each of the depressions 213 is defined by four sidewalls 2131 connected with each other. A transverse (horizontal) width of each of the sidewalls 2131 increases along a direction away from the light diffusion layer 22. As shown in FIG. 2, a transverse (horizontal) width h2 of the sidewall 2131 further from the light diffusion layer 22 is greater than a transverse (horizontal) width h1 of the sidewall 2131 closer to the light diffusion layer 22. The light diffusion layer 22 is located adjacent to the light input interface 211. The light diffusion layer 22 includes a transparent matrix resin 221, and a plurality of diffusion particles 222 dispersed in the transparent matrix resin 221. In the illustrated embodiment, the diffusion particles 222 are substantially uniformly dispersed in the transparent matrix resin 221. A thickness of each of the transparent layer 21 and the light diffusion layer 22 can be at least 0.35 millimeters. In the illustrated embodiment, a total thickness of the transparent layer 21 and the light diffusion layer 22 is in a range from about 1 millimeter to about 6 millimeters.

The transparent layer 21 can be made of one or more transparent matrix resins selected from the group including polyacrylic acid (PAA), polycarbonate (PC), polystyrene (PS), polymethyl methacrylate (PMMA), methylmethacrylate and styrene copolymer (MS), and any suitable combination thereof. The light input interface 211 of the transparent layer 21 can be either smooth or rough.

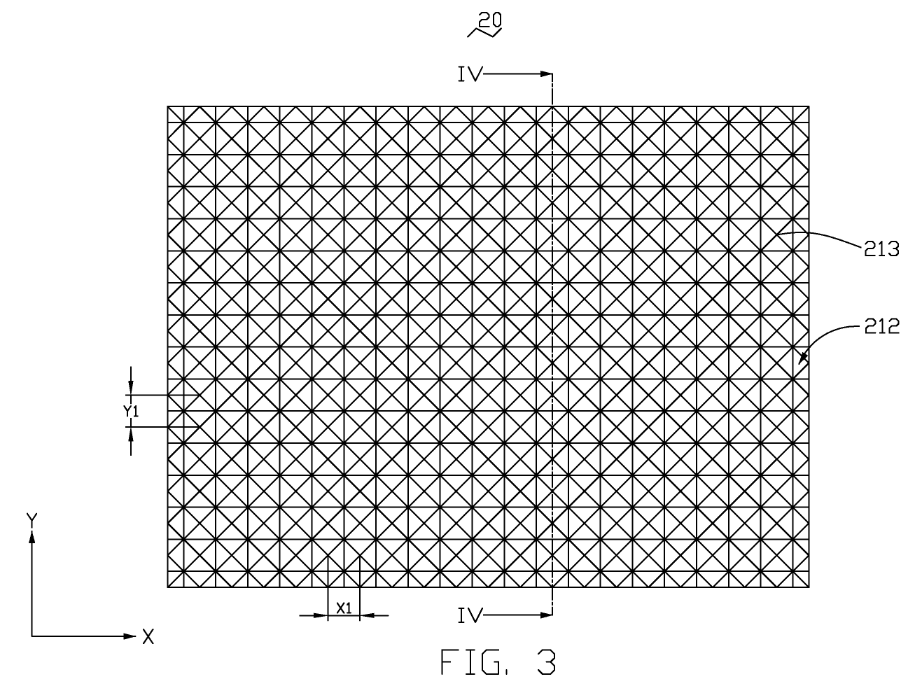

The depressions 213 of the transparent layer 21 are configured for collimating to a certain extent light emitting from the optical plate 20, thereby improving a brightness of light illumination. In the illustrated embodiment, the depressions 213 are substantially in the shape of inverted pyramids. Each of the depressions 213 includes a pair of first opposite inner sidewalls, and a pair of second opposite inner sidewalls. The sidewalls of each depression 213 are isosceles triangular sidewalls. An intersection formed by the first opposite sidewalls of each depression 213 defines a first dihedral angle. An intersection formed by the second opposite sidewalls of the depression 213 defines a second dihedral angle. In the illustrated embodiment, the first dihedral angle is equal to the second dihedral angle. That is, the depressions 213 are substantially in the shape of inverted square pyramids. Each of the first and second dihedral angles is preferably in a range from 60 degrees to 120 degrees. By appropriately configuring the first and second dihedral angles of each depression 213, a desired range of light output angles of the optical plate 20 can be obtained, and a desired amount of light enhancement provided by the optical plate 20 can be achieved. Referring to FIG. 3, a pitch X1 along an X-axis direction between adjacent depressions 213 is in a range from about 0.0025 millimeters to about 1 millimeter. A pitch Y1 along a Y-axis direction between adjacent depressions 213 is in a range from about 0.0025 millimeters to about 1 millimeter. It should be understood that in alternative embodiments, the first dihedral angle defined by the first opposite sidewalls may be different to the second dihedral angle defined by the second opposite inner sidewalls. That is, in such embodiments, the depressions are substantially in the shape of inverted rectangular pyramids.

The light diffusion layer 22 preferably has a light transmission ratio in a range from 30% to 98%. The light diffusion layer 22 is configured for enhancing uniformity of light output from the optical plate 20. The transparent matrix resin 221 can be one or more transparent matrix resins selected from the group including polyacrylic acid (PAA), polycarbonate (PC), polystyrene, polymethyl methacrylate (PMMA), polyurethane, methylmethacrylate and styrene copolymer (MS), and any suitable combination thereof. The diffusion particles 222 can be made of material selected from a group including titanium dioxide, silicon dioxide, acrylic resin, and any combination thereof. The diffusion particles 222 are configured for scattering light and enhancing a light distribution capability of the light diffusion layer 22.

When the optical plate 20 is utilized in a typical backlight module (not shown), light from lamps of the backlight module enters the light diffusion layer 22 of the optical plate 20. The light is substantially diffused in the light diffusion layer 22. Subsequently, much of the light is condensed by the depressions 213 of the transparent layer 21 before exiting the light output surface 212. As a result, a brightness of the backlight module is increased. In addition, because the transparent layer 21 and the light diffusion layer 22 are integrally formed together, few or no air or gas pockets exist at the common interface therebetween. Thus back reflection is reduced or even eliminated, and the efficiency of utilization of light is increased.

Furthermore, when the optical plate 20 is utilized in the backlight module, it can in effect replace a conventional combination of a diffusion plate and a prism sheet. Thus a process of assembly of the backlight module is simplified. Moreover, the volume occupied by the optical plate 20 is generally less than that occupied by the conventional combination of a diffusion plate and a prism sheet. Thus an overall size of the backlight module is reduced. Still further, using the single optical plate 20 instead of the combination of two optical plates/sheets can reduce manufacturing costs.

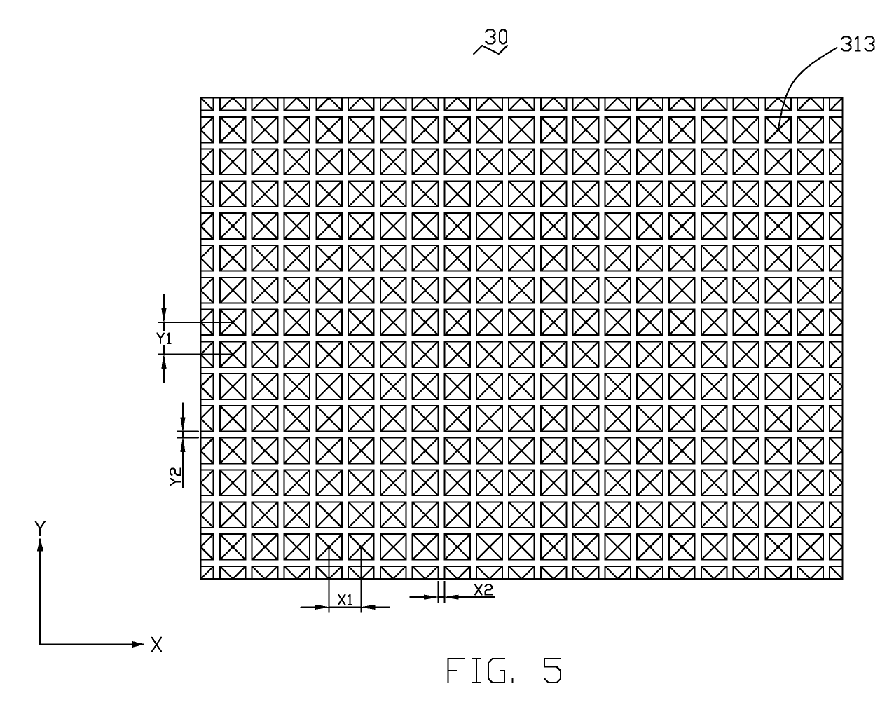

Referring to FIG. 5, an optical plate 30 according to a second embodiment is shown. The optical plate 30 is similar in principle to the optical plate 20 described above. However, in the optical plate 30, each two adjacent depressions 313 are spaced apart from each other by a distance X2 along an X-axis direction and by a distance Y2 along a Y-axis direction. The distance X2 is much less than a pitch X1 between adjacent depressions 313 along the X-axis direction. The distance Y2 is much less than a pitch Y1 between adjacent depressions 313 along the Y-axis direction.

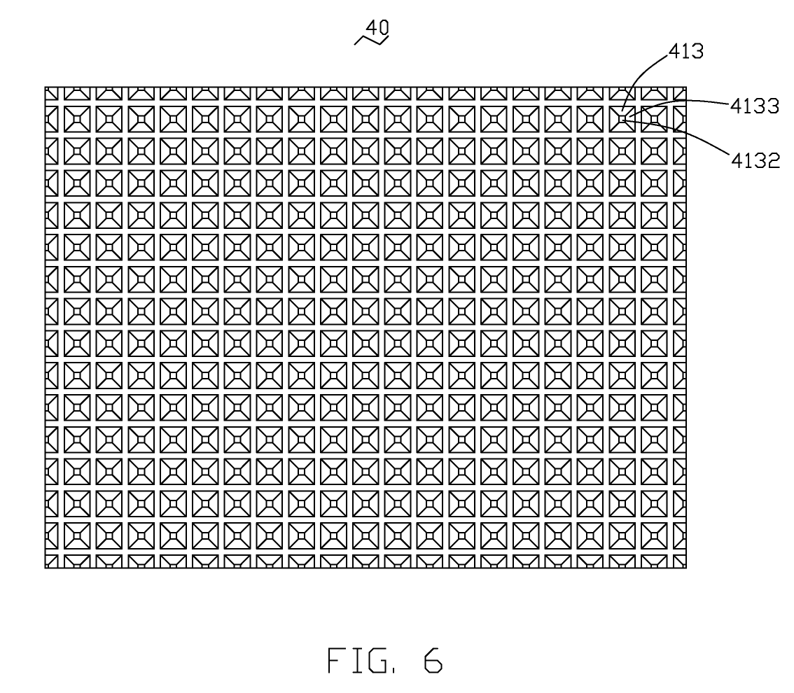

Referring to FIG. 6, an optical plate 40 according to a third embodiment is shown. The optical plate 40 is similar in principle to the optical plate 30 described above. However, the optical plate 40 includes a plurality of depressions 413. In the illustrated embodiment, the depressions 413 are substantially in the shape of inverted rectangular pyramidal frustums. Each of the depressions 413 includes a pair of first opposite sidewalls 4133, a pair of second opposite sidewalls 4133, and a bottom surface 4132 connecting with the four sidewalls 4133. In the illustrated embodiment, the four sidewalls 4133 of each depression 213 are isosceles trapezoids, and have the same size. The bottom surface 4132 is square. That is, the depressions 413 are substantially in the shape of inverted square pyramidal frustums.

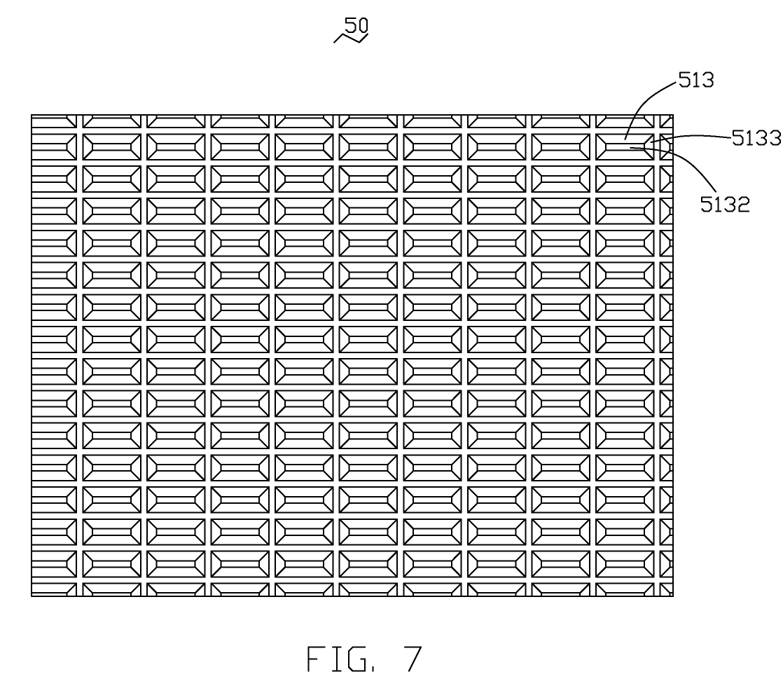

Referring to FIG. 7, an optical plate 50 according to a fourth embodiment is shown. The optical plate 50 is similar in principle to the optical plate 40 described above. However, the optical plate 50 includes a plurality of depressions 513. Each of the depressions 513 includes a pair of first opposite sidewalls 5133, a pair of second opposite sidewalls 5133, and a bottom surface 5132. The first opposite sidewalls 5133 are isosceles trapezoids, and the second opposite sidewalls 5133 are isosceles trapezoids. The first opposite sidewalls 5133 are larger than the second opposite sidewalls 5133. In alternative embodiments, each of the depressions can instead have three, five, or more than five inner sidewalls. In such embodiments, the bottom surface is a corresponding triangle, pentagon, or polygon. That is, the depressions are substantially in the shape of inverted triangular pyramidal frustums, inverted pentagonal pyramidal frustums, or inverted polygonal pyramidal frustums.

An exemplary method for making the optical plate 20 will now be described. The optical plate 20 is made using a two-shot injection molding technique.

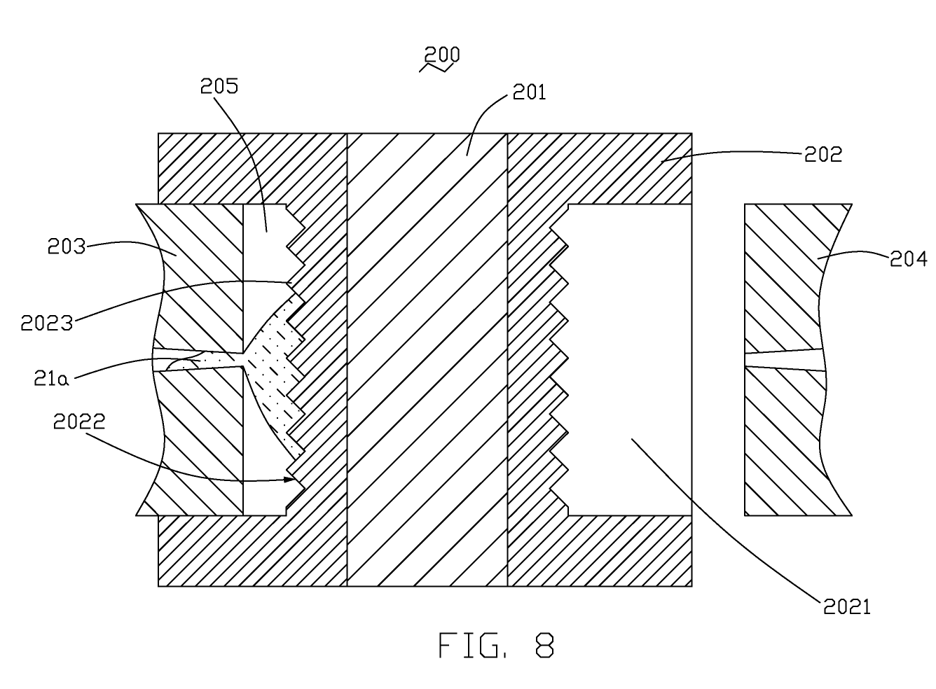

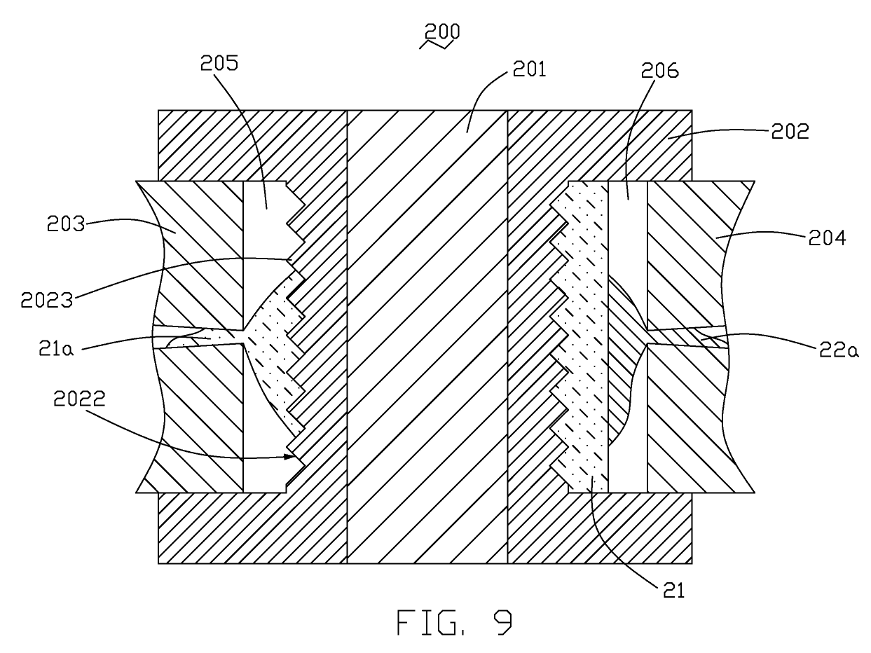

Referring to FIGS. 8-9, a two-shot injection mold 200 is provided for making the optical plate 20. The two-shot injection mold 200 includes a rotatable device 201, a first mold 202 functioning as two female molds, a second mold 203 functioning as a first male mold, and a third mold 204 functioning as a second male mold. The first mold 202 defines two molding cavities 2021, and includes an inmost surface 2022 at an inmost end of each of the molding cavities 2021. The first mold 202 includes a plurality of protrusions 2023 arranged regularly in a matrix at each of the inmost surfaces 2022. Each of the protrusions 2023 has a shape corresponding to the shape of each of the depressions 213 of the optical plate 20. That is, each of the protrusions 2023 is configured to be a rectangular pyramid having a first opposite pair of sidewalls and a second opposite pair of sidewalls. The sidewalls are triangular. A transverse width of each sidewall of each protrusion 2023 decreases along a direction from a base end of each protrusion 2023 to an outmost end of the protrusion 2023.

In a molding process, a first transparent matrix resin 21a is melted. The first transparent matrix resin 21a is for making the transparent layer 21. A first one of the molding cavities 2021 of the first mold 202 slidably receives the second mold 203, so as to form a first molding chamber 205 for molding the first transparent matrix resin 21a. Then, the melted first transparent matrix resin 21a is injected into the first molding chamber 205. After the transparent layer 21 is formed, the second mold 203 is withdrawn from the first molding cavity 2021. The first mold 202 is rotated about 180° in a first direction. A second transparent matrix resin 22a is melted. The second transparent matrix resin 22a is for making the light diffusion layer 22. The first molding cavity 2021 of the first mold 202 slidably receives the third mold 204, so as to form a second molding chamber 206 for molding the second transparent matrix resin 22a. Then, the melted second transparent matrix resin 22a is injected into the second molding chamber 206. After the light diffusion layer 22 is formed, the third mold 204 is withdrawn from the first molding cavity 2021. The first mold 202 is rotated further in the first direction, for example about 90 degrees. The solidified combination of the transparent layer 21 and the light diffusion layer 22 is removed from the first molding cavity 2021, such solidified combination being the optical plate 20. In this way, the optical plate 20 is formed using the two-shot injection mold 200.

As shown in FIG. 9, when the light diffusion layer 22 is being formed in the first molding cavity 2021, simultaneously, a transparent layer 21 for a second optical plate 20 can be formed in the second one of the molding cavities 2021. Once the first optical plate 20 is removed from the first molding cavity 2021, the first mold 202 is rotated still further in the first direction about 90 degrees back to its original position. Then the first molding cavity 2021 slidably receives the second mold 203 again, and a third optical plate 20 can begin to be made in the first molding chamber 205. Likewise, the second molding cavity 2021 having the transparent layer 21 for the second optical plate 20 slidably receives the third mold 204, and a light diffusion layer 22 for the second optical plate 20 can begin to be made in the second molding chamber 206.

In an alternative embodiment of the above-described molding process(es), after the third mold 204 is withdrawn from the first molding cavity 2021, the first mold 202 can be rotated in a second direction opposite to the first direction. For example, the first mold 202 can be rotated about 90 degrees in the second direction. Then the solidified combination of the transparent layer 21 and the light diffusion layer 22 is removed from the first molding cavity 2021, such solidified combination being the first optical plate 20. Once the first optical plate 20 has been removed from the first molding cavity 2021, the first mold 202 is rotated further in the second direction about 90 degrees back to its original position.

The transparent layer 21 and light diffusion layer 22 of each optical plate 20 are integrally formed by the two-shot injection mold 200. Therefore little or no air or gas is trapped between the transparent layer 21 and light diffusion layer 22. Thus the common interface between the two layers 21, 23 provides for maximum unimpeded passage of light therethrough.

It should be understood that the first optical plate 20 can be formed using only one female mold, such as that of the first mold 202 at the first molding cavity 2021 or the second molding cavity 2021, and one male mold, such as the second mold 203 or the third mold 204. For example, a female mold such as that of the first molding cavity 2021 can be used with a male mold such as the second mold 203. In this kind of embodiment, the transparent layer 21 is first formed in a first molding chamber cooperatively formed by the male mold moved to a first position and the female mold. Then the male mold is separated from the transparent layer 21 and moved a short distance to a second position. Thus a second molding chamber is cooperatively formed by the male mold, the female mold, and the transparent layer 21. Then the light diffusion layer 22 is formed on the transparent layer 21 in the second molding chamber.

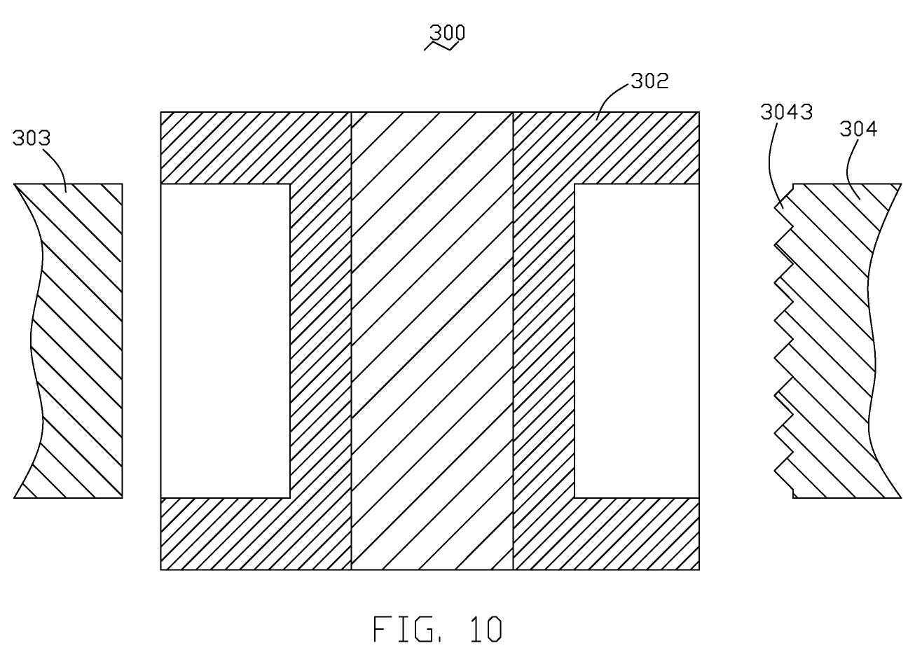

Referring to FIG. 10, in an alternative exemplary method for making the optical plate 20, a two-shot injection mold 300 is provided. The two-shot injection mold 300 is similar in principle to the two-shot injection mold 200 described above, except that a plurality of protrusions 3023 are formed at a molding surface of a third mold 304. The protrusions 3023 are arranged regularly in a matrix. Each of the protrusions 3023 has a shape corresponding to the shape of each of the depressions 213 of the optical plate 20. The third mold 304 functions as a second male mold. In the method for making the optical plate 20 using the two-shot injection mold 300, firstly, a melted first transparent matrix resin is injected into a first molding chamber formed by a first mold 302 and a second mold 303, so as to form the light diffusion layer 22. Then, the first mold 302 is rotated 180° in a first direction. The first mold 302 slidably receives the third mold 304, so as to form a second molding chamber. A melted second transparent matrix resin is injected into the second molding chamber, so as to form the transparent layer 21 on the light diffusion layer 22.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1-11. (canceled)

12. A method for making at least one optical plate, comprising:
heating a first transparent matrix resin to a melted state;
heating a second transparent matrix resin to a melted state;
injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of protrusions formed at an inmost end of the at least one molding cavity, each protrusion including at least three sidewalls, a transverse width of each sidewall decreasing along a direction from a base end of the protrusion to an outmost end of the protrusion, a portion of the at least one molding cavity and the at least one male mold cooperatively forming the first molding chamber;
moving the at least one male mold a distance away from the inmost end of the at least one molding cavity of the female mold;
injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and
taking the combined transparent layer and light diffusion layer out of the at least one molding cavity of the female mold.

13. The method for making at least one optical plate as claimed in claim 12, wherein the second transparent matrix resin has a plurality of diffusion particles dispersed therein.

14. The method for making at least one optical plate as claimed in claim 13, wherein the second transparent matrix resin is made of material selected from the group consisting of polyacrylic acid, polycarbonate, polystyrene, polymethyl methacrylate, polyurethane, methylmethacrylate and styrene copolymer, and any combination thereof, and the diffusion particles are made of material selected from the group consisting of titanium dioxide, silicon dioxide, acrylic resin, and any combination thereof.

15. The method for making at least one optical plate as claimed in claim 12, wherein the two-shot injection mold further includes a rotatable device, the at least one male mold is two male molds, the at least one molding cavity is two molding cavities, a first one of the molding cavities receives a first one of the male molds to define the first molding chamber, and after the melted first transparent matrix resin is injected into the first molding chamber, the first male mold is withdrawn from the first molding cavity of the female mold, and the female mold is rotated, and after the female mold is rotated, the first molding cavity receives the second male mold to define the second molding chamber, and the second molding cavity receives the first male mold to define the first molding chamber in order to form a transparent layer for another one of the at least one optical plate.

16. The method for making at least one optical plate as claimed in claim 12, wherein when the at least one male mold is moved a distance away from the inmost end of the at least one molding cavity of the female mold, the at least one male mold remains substantially in the at least one molding cavity in order to form the second molding chamber.

17. A method for making an optical plate, comprising:
heating a first transparent matrix resin to a melted state;
heating a second transparent matrix resin to a melted state;
injecting the melted first transparent matrix resin into a first molding chamber of a two-shot injection mold to form a light diffusion layer of the optical plate, the two-shot injection mold including a female mold and two male molds, the female mold defining a molding cavity receiving a first one of the male molds, a portion of the molding cavity and the first male mold cooperatively forming the first molding chamber;
withdrawing the first male mold from the female mold;
injecting the melted second transparent matrix resin into a second molding chamber of the two-shot injection mold to form a transparent layer of the optical plate on the light diffusion layer, the molding cavity of the female mold receiving the second one of the male molds, the second male mold including a plurality of protrusions formed at a molding surface thereof, each protrusion including at least three sidewalls, a transverse width of each sidewall decreasing along a direction from a base end of the protrusion to an outmost end of the protrusion, a portion of the molding cavity, the light diffusion layer, and the second male mold cooperatively forming the second molding chamber; and
taking the combined light diffusion layer and transparent layer out of the molding cavity of the female mold.

18. The method for making an optical plate as claimed in claim 17, wherein the first transparent matrix resin has a plurality of diffusion particles dispersed therein.

19. The method for making an optical plate as claimed in claim 18, wherein the first transparent matrix resin is made of material selected from the group consisting of polyacrylic acid, polycarbonate, polystyrene, polymethyl methacrylate, polyurethane, methylmethacrylate and styrene copolymer, and any combination thereof

20. The method for making an optical plate as claimed in claim 19, wherein the diffusion particles are made of material selected from the group consisting of titanium dioxide, silicon dioxide, acrylic resin, and any combination thereof
